(19) United States
(12) Patent Application Publication
(10) Pub. No.: US 2020/0247216 A1
(43) Pub. Date: Aug. 6, 2020

(54) VEHICLE HEADLINER EQUIPPED WITH AN AIR VENT SYSTEM

(71) Applicants: HYUNDAI MOTOR COMPANY, Seoul (KR); KIA MOTORS CORPORATION, Seoul (KR); DAEHAN SOLUTION CO., LTD, Incheon (KR)

(72) Inventors: Min Ho Cho, Suwon-si (KR); Jin Ho Hwang, Seoul (KR); Dae Ig Jung, Suwon-si (KR); Seung Hyeok Chang, Suwon-si (KR); Choong Ho Kwon, Seoul (KR); Soon Kyu Lee, Incheon (KR); Kang Hee Jo, Anyang-si (KR)

(73) Assignees: HYUNDAI MOTOR COMPANY, Seoul (KR); KIA MOTORS CORPORATION, Seoul (KR); DAEHAN SOLUTION CO., LTD, Incheon (KR)

(21) Appl. No.: 16/265,512

(22) Filed: Feb. 1, 2019

(51) Int. Cl. B60H 1/24; B60R 13/02; B32B 3/26; B32B 5/24; B32B 7/12; B32B 5/26; B32B 5/02

(52) U.S. Cl. CPC B60H 1/245; B60R 13/0212; B32B 3/266; B32B 5/245; B32B 2605/00; B32B 5/26; B32B 5/022; B32B 2262/101; B32B 2266/0278; B32B 7/12

(57) ABSTRACT

A vehicle headliner is equipped with an air vent system, which includes a vent base member having a surface which faces a roof panel and on which a roof duct is mounted. The vent base member has multiple vent holes so that a fluid is sprayed toward a vehicle interior. A breathable surface layer is mounted on a surface of the vent base member which is exposed to the vehicle interior. The vent base member may include a polyurethane foam, fiberglass mats, which are attached to both surfaces of the polyurethane foam by glue, respectively, and non-woven fabrics, which are attached through hot melt films to surfaces of the fiberglass mats, respectively, which are opposite to the surfaces attached to the polyurethane foam.

### BACKGROUND

### (a) Field of the Disclosure

The present disclosure relates to a vehicle headliner equipped with an air vent system, and more particularly, to a vehicle headliner equipped with an air vent system.

### (b) Description of the Related Art

In general, an air conditioning device is provided in a vehicle to adjust a temperature and a humidity level in a vehicle interior and to purify air. The air conditioning device functions to circulate inside air in the vehicle interior or introduce outside air into the vehicle interior. The air conditioning device is supplied with inside air or outside air and creates cold air or hot air to adjust a temperature in the vehicle interior. The air conditioning device introduces the created cold air or the created hot air into the vehicle interior through air vent grills.

The air vent grill may also be mounted on a headliner. Herein, the headliner refers to a finishing material for absorbing and blocking noise that may be transmitted to the vehicle interior. The headliner is mounted on a roof panel of the vehicle.

A fluid is supplied from the air conditioning device through a roof duct mounted in the headliner and the fluid is sprayed through the headliner. In addition, the air vent grill is mounted on the headliner that faces the roof duct. However, the air vent grill mounted on the headliner has the following problems.

The air vent grill exposed to the vehicle interior may degrade an aesthetic appearance. In addition, an interval between the air vent grills in the related art is large, such that an occupant may feel unpleasant when the fluid sprayed between the neighboring two grills is transferred directly to the occupant. In particular, a strong wind, which is transferred directly to the skin, may be harmful to an old or weak person having weak skin and to a patient suffering from a skin disease. Further, a process of separately manufacturing and coupling the air vent grill and the headliner may be complicated. The complicated process may further cause an increase in manufacturing costs and an increase in the number of manufacturing processes.

The above information disclosed in this Background section is only to enhance understanding of the background of the disclosure. Therefore, the Background section may contain information that does not form the prior art that is already known in this country to a person of ordinary skill in the art.

### SUMMARY

The present disclosure relates to a vehicle headliner equipped with an air vent system, in which vent holes are formed in a base member which is disposed between a roof panel and a vehicle interior and faces the roof panel, and a surface of the base member, which is exposed to the vehicle interior, is formed with a breathable surface layer, such that a vent grill in the related art is eliminated, a vent function is ensured, an aesthetic appearance is not degraded, and a sufficient ventilation rate is ensured.

The present disclosure has been made in an effort to describe a vehicle headliner equipped with an air vent system. The air vent system includes a base member having several vent holes and a breathable surface layer and is used to spray a fluid in a state in which a separate air vent grill is eliminated.

The present disclosure has also been made in an effort to describe a vehicle headliner equipped with an air vent system, which enables an occupant to feel pleasant even though a fluid, which passes through a breathable surface layer through vent holes, is transferred directly to the occupant.

The present disclosure has also been made in an effort to describe a vehicle headliner equipped with an air vent system with a portion, which may degrade an aesthetic appearance, is not exposed to a vehicle interior. Thus, a degree of design freedom may be improved and an aesthetic appearance of the vehicle interior may be improved while a function identical to or more improved than an air vent grill in the related art is performed.

An embodiment of the present disclosure provides a vehicle headliner equipped with an air vent system. The vehicle headliner includes a vent base member having a surface, which faces a roof panel and on which a roof duct is mounted. The vent base member has multiple vent holes so that a fluid is sprayed toward a vehicle interior. The vehicle headliner includes a breathable surface layer mounted on a surface of the vent base member, which is exposed to the vehicle interior.

The vent base member may include a polyurethane foam, fiberglass mats, which are attached to both surfaces of the polyurethane foam by glue, respectively, and non-woven fabrics, which are attached, through hot melt films, to surfaces of the fiberglass mats, respectively, which are opposite to the surfaces attached to the polyurethane foam.

The multiple vent holes may be processed by a laser or punching.

The breathable surface layer may include a polyurethane foam, and a breathable raw material mounted on one surface of two surfaces of the polyurethane foam, the one surface facing the vehicle interior. The breathable surface layer may also include a hot melt film mounted on a surface of the two surfaces of the polyurethane foam that is opposite to the one surface. The hot melt film may have ventilation holes and may be attached to the vent base member by thermal bonding. The hot melt film may be made of polyethylene terephthalate (PET).

The breathable raw material and the hot melt film may be attached to the breathable surface layer by a flame lamination method or process. In addition, breathability of the breathable surface layer may be 191 to 227 cc/cm²/sec.

A diameter of each of the multiple vent holes may be 3 to 7 mm. A distance between neighboring vent holes may be 3 to 7 mm. The vent holes may be arranged in a quadrangular area, one side of which may have a length of 200 to 260 mm.

The vent base member, the hot melt film, and the breathable surface layer may be formed by hot press forming at a mold temperature of 110 to 150° C.

### BRIEF DESCRIPTION OF THE DRAWINGS

FIG. 1 is a side view of a vehicle, which illustrates a position at which a vehicle headliner is mounted, the vehicle headliner equipped with an air vent system according to an embodiment of the present disclosure.

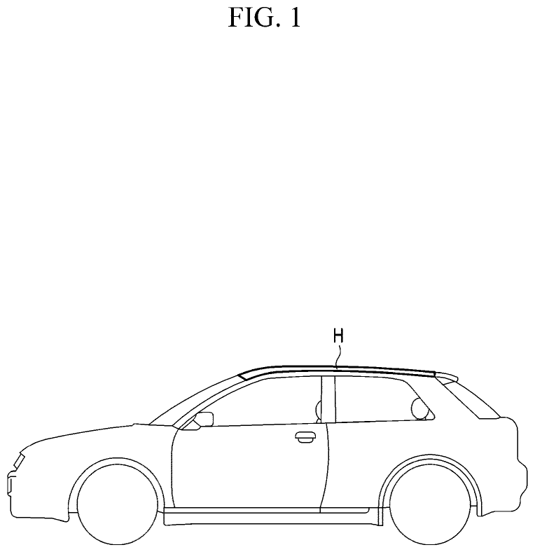

FIG. 2 is a cross-sectional view of the vehicle headliner equipped with the air vent system according to an embodiment of the present disclosure.

FIG. 3 is an enlarged cross-sectional view illustrating a stacked structure of the vehicle headliner equipped with the air vent system according to an embodiment of the present disclosure.

FIG. 4 is a schematic view illustrating a process of manufacturing a breathable surface layer according to an embodiment of the present disclosure.

FIG. 5A is a view illustrating a vent base member according to an embodiment of the present disclosure.

FIG. 5B is a partially enlarged view of FIG. 5A and illustrates vent holes formed in the vent base member according to an embodiment of the present disclosure.

FIG. 6 is a view illustrating an example of a breathable raw material according to an embodiment of the present disclosure.

### DETAILED DESCRIPTION OF THE EMBODIMENTS

An embodiment of the present disclosure will hereinafter be described in detail with reference to the accompanying drawings.

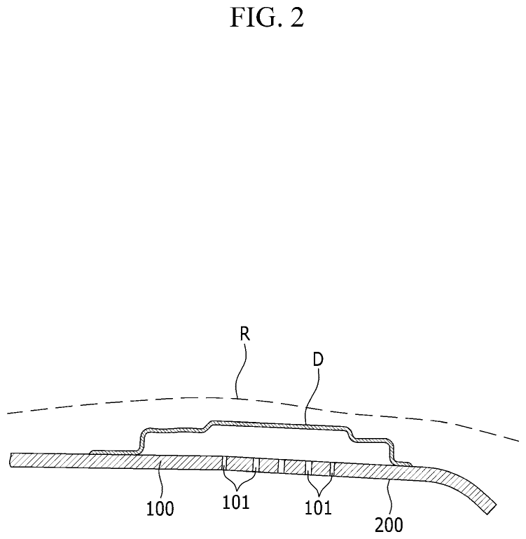

As illustrated in FIGS. 2-5, a vehicle headliner equipped with an air vent system according to an embodiment of the present disclosure includes a vent base member 100 having vent holes 101 formed therein. A breathable surface layer 200 is mounted on the vent base member 100.

A fluid passing through the vent holes 101 is sprayed into a vehicle interior through the breathable surface layer 200. Therefore, the fluid is prevented from being sprayed into the vehicle interior with high pressure, such that safety and convenience may be implemented.

A roof duct D is mounted on a surface of the headliner that faces a roof panel R. The fluid such as cold air or hot air created by an air conditioning device is supplied through the roof duct D so that the fluid is sprayed into the vehicle interior through the headliner.

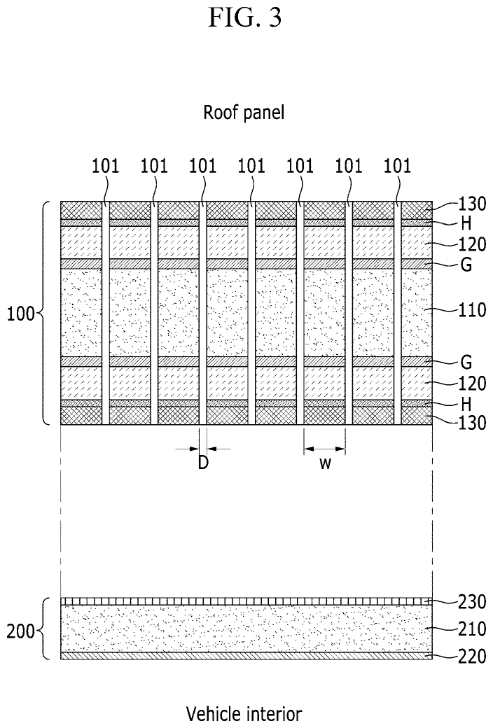

The multiple vent holes 101 are formed in a surface of the vent base member 100 that faces the roof duct D (see FIGS. 2 and 3). The vent holes 101 may be formed throughout the entire roof duct D. However, in consideration of a seat for an occupant, the vent holes 101 may be formed at positions at which the fluid is directed toward an occupant.

In particular, a diameter D of each of the vent holes 101 and a distance W between one vent hole and another neighboring vent hole may be 3 to 7 mm. In one embodiment, the diameter and the distance may each be 5 mm (see FIG. 3). The diameter and the spacing is to prevent the fluid passing through the vent base member 100 and the breathable surface layer 200 from being sprayed into the vehicle interior too strongly. Therefore, it is possible to make an interior environment in which the occupant feels pleasant.

The vent holes 101 may be arranged in a quadrangular area, one side of which has a length of 200 to 260 mm. The quadrangle area and length is to stably spray the fluid with a restricted fluid pressure provided by the air conditioning device. In other words, in a case in which the fluid is sprayed toward an excessively large area, the pressure of the fluid provided from the air conditioning device needs to be high to accommodate the large area. As a result, there is a limitation in stably spraying the fluid. The area in which the vent holes 101 are arranged is not limited to the quadrangular area. The area may have various shapes such as a circular shape in accordance with design parameters. Persons having ordinary skill in the technical field (hereinafter, referred to as ‘those having ordinary skill in the art’) may consider a shape of the roof duct D and spraying positions of the vent holes 101.

The vent holes 101 may be formed in the vent base member 100 by various methods such as punching. The vent holes 101 may also be formed by a laser processing method. The laser processing method may facilitate the precise processing the vent holes 101 having a small diameter.

The vent base member 100 may further adopt a configuration of a base member, which is used to manufacture a headliner in the related art. However, the vent base member 100 according to an embodiment of the present disclosure may include a polyurethane foam 110, fiberglass mats 120, and non-woven fabrics 130 (see FIG. 3).

The polyurethane foam 110 is made of a porous material, such that the polyurethane foam 110 has an excellent sound absorbing performance and high strength and may be easily manufactured in a desired form. Therefore, the headliner, which has a complicated shape and faces the roof panel R, may be easily manufactured.

The fiberglass mats 120 are attached to both surfaces of the polyurethane foam 110, respectively. In this case, the fiberglass mat 120 may be attached to the polyurethane foam 110 using glue G. However, the present disclosure is not limited thereto. A hot melt film or a breathable film may be used instead of the glue G.

The non-woven fabrics 130 are attached at both sides of the polyurethane foam 110 and installed on the fiberglass mats 120 exposed to the outside. The non-woven fabric 130 serves to maintain an overall shape of the vent base member 100 and absorb moisture from the roof panel R or the vehicle interior.

The vent base members 100 are installed to face the roof panel R. The fluid passing through the roof duct D mounted on the surface facing the roof panel R may be sprayed into the vehicle interior through the vent holes 101 (see FIGS. 2 and 3).

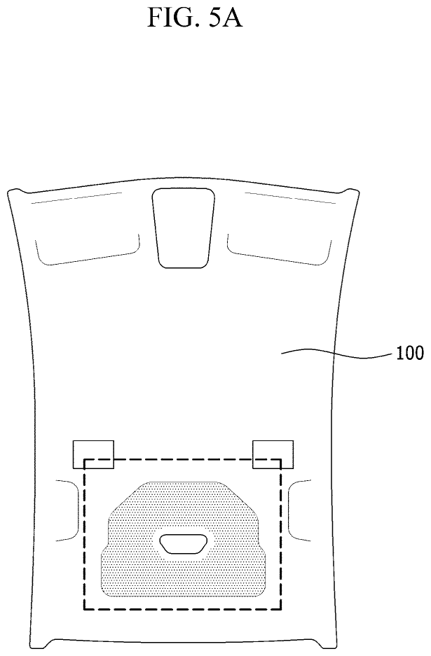

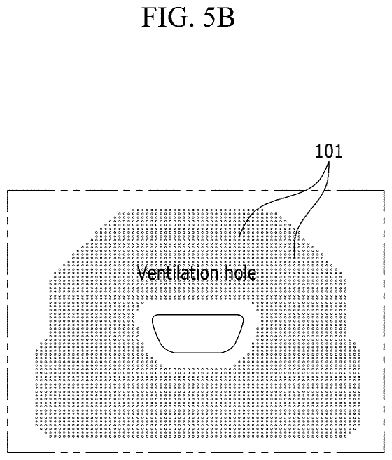

FIG. 5 illustrates an example in which the vent holes are formed in the vent base member 100 manufactured according to the embodiment of the present disclosure.

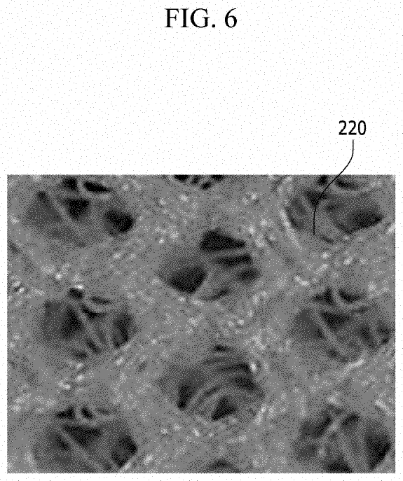

As illustrated in FIGS. 2-4, the breathable surface layer 200 is manufactured such that the fluid sprayed through the vent holes 101 passes through the breathable surface layer 200. To this end, a breathable raw material 220, which permits the fluid to pass therethrough, may be applied as a single layer structure to the breathable surface layer 200. The breathable raw material 220 may be cotton, felt, non-woven fabric, microfiber fabric, polar fleece, velvet, velboa, cotton cloth, twill raw fabric, denim, quilt, towels, suede raw fabric, or the like. In the case in which the breathable raw material 220 having the single layer structure is used, transmittance of the fluid may be adjusted by changing manufacturing methods in accordance with the materials. FIG. 6 illustrates an example of the breathable raw material 220.

In addition, the breathable surface layer 200 may include a polyurethane foam 210, the breathable raw material 220, and a hot melt film 230.

The fluid passing through the vent holes 101 passes through the polyurethane foam 210. The vent holes 101 are also formed in the breathable surface layer 200 together with the vent base member 100.

The breathable raw material 220 is mounted on one surface of the polyurethane foam 210. In addition, the breathable raw material 220 is exposed to the vehicle interior and serves as a passageway through which the fluid sprayed through the roof duct D may pass.

Further, the hot melt film 230 is mounted on the other surface of the polyurethane foam 210, that surface being opposite to the surface on which the breathable raw material 220 is mounted. Here, ventilation holes are formed in advance in the hot melt film 230. The hot melt film 230 is used to attach the breathable surface layer 200 to the vent base member 100 by thermal bonding. In addition, the ventilation holes enable the fluid supplied through the vent holes 101 to pass through the breathable surface layer 200 even after thermal bonding. The hot melt film 230 may be made of various materials but may be made of polyethylene terephthalate (PET). Meanwhile, a breathable film having a bonding force and ventilation holes may be used in addition to the hot melt film 230.

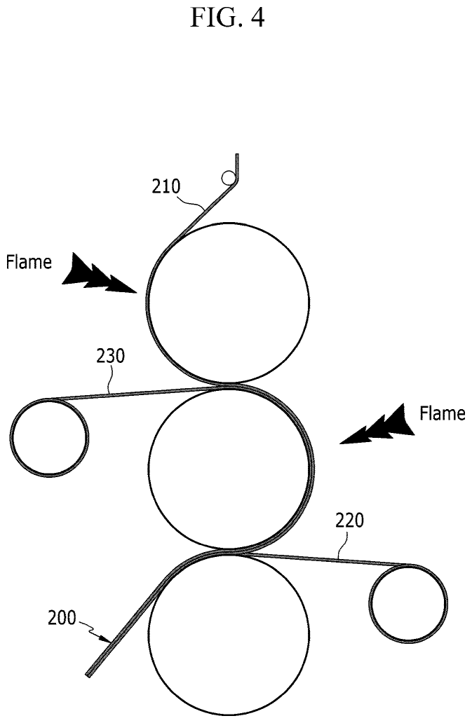

The vent base member 100, the hot melt film 230, and the breathable surface layer 200 may be formed by hot press forming, at a mold temperature of 110 to 150° C., and in a state in which the vent base member 100 is in contact with the breathable surface layer 200 with the hot melt film 230 interposed therebetween. The breathable surface layer 200 may be manufactured by various methods but may be manufactured by a flame lamination method (see FIG. 4). Here, the flame lamination method refers to a method of attaching the hot melt film 230 to one surface of the breathable surface layer 200 while continuously supplying heat to the one surface of the breathable surface layer 200, and simultaneously attaching the breathable raw material 220 to the other surface of the breathable surface layer 200 while supplying heat to the other surface of the breathable surface layer 200.

It can be seen from the following Tables 1 and 2 that the breathable surface layer 200 according to the embodiment of the present disclosure has excellent breathability and an excellent ventilation rate.

TABLE 1

| | | Breathability |
|---|---|---|
| Classification | Configuration | (cc/cm²/sec) |
| Example | Breathable raw | 227 |
| | material + Hot | |
| | melt film | |
| Comparative | Raw fabric in | 59 |
| Example 1 | the related art + | |
| | Hot melt film | |
| Comparative | Raw fabric in | 0 |
| Example 2 | the related art + | |
| | Film in the | |
| | related art | |

TABLE 2

| Stage of air conditioner | Ventilation rate (CMH) |
|---|---|
| 1 | 35 |
| 2 | 54.5 |
| 3 | 67.9 |
| 4 | 85.2 |
| 5 | 97.3 |
| 6 | 111.6 |
| 7 | 135.4 |
| 8 | 136.8 |

Headliner was mounted in HI vehicle and ventilation rate was evaluated.

For example, as can be seen from Table 1, the breathability of the breathable surface layer 200 is superior by about 4 times compared to the breathability of the raw fabric in the related art. Also, as can be seen from Table 2, efficiency in increasing the ventilation rate may be improved as the stage of the air conditioner is increased. Further, the breathability of the breathable surface layer 200 according to the embodiment of the present disclosure may be 191 to 227 cc/cm²/sec. Here, it is apparent to those having ordinary skill in the art that separate vent holes may be formed in the breathable surface layer 200. Also, holes for ventilation may be formed by changing manufacturing methods in accordance with the materials in order to prevent deterioration in breathability of the breathable surface layer 200.

According to the embodiment of the present disclosure as described above, the fluid passing through the roof duct D is not sprayed directly to the occupant but sprayed through the breathable surface layer. Thus, the fluid is prevented from being sprayed directly to the occupant, the occupant does not feel unpleasant, and a stable and smooth air conditioning may be implemented. In addition, the vent base member 100 and the breathable surface layer 200 are integrally formed. As a result, it is possible to eliminate an air vent grill in the related art that is required to spray a fluid. Therefore, the process and costs required to manufacture the air vent grill and the process and costs required to mount the manufactured air vent grill on the headliner are eliminated, such that productivity may be improved. Further, the air vent grill, which is exposed to the vehicle interior, is eliminated, such that an aesthetic appearance may be improved. Furthermore, a space for mounting the air vent grill is not needed, such that a degree of design freedom of the headliner may be improved.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A vehicle headliner equipped with an air vent system, the vehicle headliner comprising:
a vent base member having a surface, which faces a roof panel and on which a roof duct is mounted, the vent base member having multiple vent holes so that a fluid is sprayed toward a vehicle interior; and
a breathable surface layer mounted on a surface of the vent base member, which is exposed to the vehicle interior.

2. The vehicle headliner of claim 1, wherein the vent base member further comprises:
a polyurethane foam;
fiberglass mats, which are attached to both surfaces of the polyurethane foam by glue, respectively; and
non-woven fabrics, which are attached, through hot melt films, to surfaces of the fiberglass mats, respectively, which are opposite to the surfaces attached to the polyurethane foam.

3. The vehicle headliner of claim 1, wherein the multiple vent holes are processed by a laser or punching.

4. The vehicle headliner of claim 1, wherein the breathable surface layer further comprises:
a polyurethane foam;
a breathable raw material mounted on one surface of two surfaces of the polyurethane foam, the one surface facing the vehicle interior; and
a hot melt film mounted on a surface of the two surfaces of the polyurethane foam that is opposite to the one surface, the hot melt film having ventilation holes and being attached to the vent base member by thermal bonding.

5. The vehicle headliner of claim 4, wherein the hot melt film is made of polyethylene terephthalate (PET).

6. The vehicle headliner of claim 5, wherein the breathable raw material and the hot melt film are attached to the breathable surface layer by a flame lamination process.

7. The vehicle headliner of claim 4, wherein breathability of the breathable surface layer is 191 to 227 cc/cm²/sec.

8. The vehicle headliner of claim 5, wherein a diameter of the multiple vent holes is 3 to 7 mm, a distance between neighboring vent holes is 3 to 7 mm, and
the multiple vent holes are arranged in a quadrangular area, one side of which has a length of 200 to 260 mm.

9. The vehicle headliner of claim 5, wherein the vent base member, the hot melt film, and the breathable surface layer are formed by hot press forming at a mold temperature of 110 to 150° C.
